(19) United States
(12) Patent Application Publication
(10) Pub. No.: US 2008/0209360 A1
(43) Pub. Date: Aug. 28, 2008

(54) METHODS AND SYSTEMS FOR ALTERING AN AXIS OF A GRAPHICAL DISPLAY

(75) Inventor: Jason Brian Myers, Portland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: CAPSTONE TECHNOLOGY CORPORATION, Camas, WA (US)

(21) Appl. No.: 11/679,557

(22) Filed: Feb. 27, 2007

(51) Int. Cl. G06F 3/048

(52) U.S. Cl. 715/799

(57) ABSTRACT

Embodiments of the present invention provide methods and systems for altering an axis of a graphical display. Other embodiments may be described and claimed.

### TECHNICAL FIELD

Embodiments of the present invention relate to the field of data processing, and more particularly, to methods and systems for altering an axis of a graphical display.

### BACKGROUND

Many types of industries such as, for example, manufacturing plants, power generation plants, service oriented industries, etc., have various operational and managerial characteristics related to their functionality. In order for proper operation, optimization, troubleshooting and management of such “plants,” it is desirable to monitor and analyze data associated with their operational and managerial characteristics. Quickly changing or altering relationships of the various characteristics with respect to desired characteristics, each other and time is often important for making quick decisions with regard to proper functioning of a plant.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 schematically illustrates an exemplary embodiment of a computer network that may be utilized within an enterprise that may be comprised of one or more sites, in accordance with various embodiments of the present invention;

FIG. 2 schematically illustrates an exemplary embodiment of a server that may be utilized within an enterprise that may be comprised of one or more sites, in accordance with various embodiments of the present invention;

FIG. 3 is a schematic illustration of an exemplary client device, in accordance with various embodiments of the present invention;

FIG. 4 is a schematic illustration of two exemplary graphical displays, in accordance with various embodiments of the present invention; and

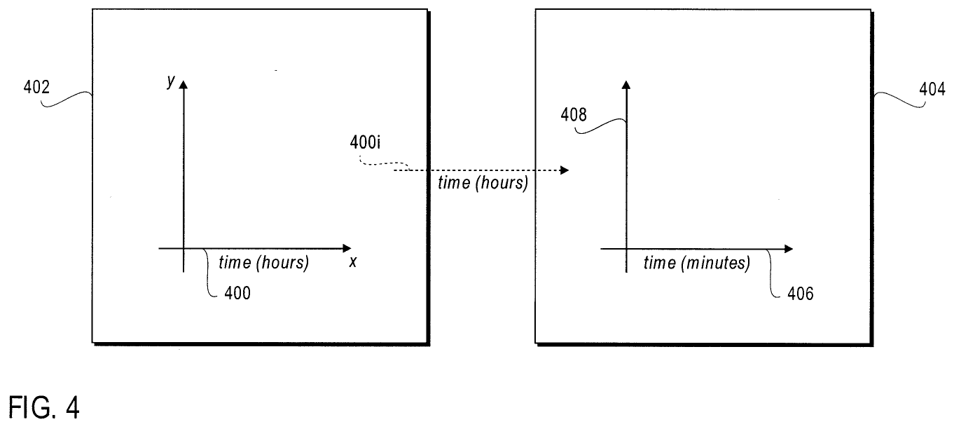

FIG. 5 is a schematic illustration of an exemplary graphical display, in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide methods and systems for altering an axis of a graphical display.

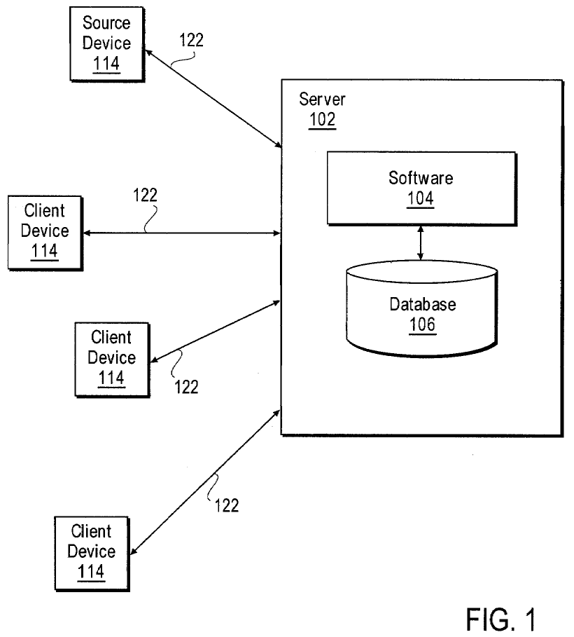

Referring now to FIG. 1, an overview of the present invention, in accordance with various embodiments, may be described. As illustrated, for the embodiments, server 102 may be endowed with software 104, which is adapted with functions to provide data and data analysis to client devices. In particular, as will be described in more detail below, software 104 may be adapted to provide client devices 112 with summary data and data analysis relating to plant operation and management issues.

For the various embodiments, server 102 may also be provided with database 106 having data relating to the operation and management of a plant. In alternate embodiments, database 106 may be remotely disposed away from server 102 instead.

In various embodiments, software 104 presents the summary data in graphical form on client devices 112. In particular, software 104 may present and display the summary data directly to the client devices in response to the client devices accessing the server. For various embodiments, software 104 may present the summary data in the form of web pages. That is, server 102 may be further endowed with a web server and various communication interfaces, whereas client devices may be endowed with a browser and corresponding communication devices.

In other embodiments, the summary data may be presented in other formats, e.g. as an attachment to electronic communications, as printed mailings, and so forth.

For the various embodiments, client devices 112 may be communicatively coupled to server 102 via network connections 122 over a number of private and/or public networks, including, but not limited to, the Internet. The communications between client devices 112 and server 102 may be conducted in accordance with one of a number of messaging protocols, including but not limited to, e.g., the HTTP protocol (HTTP=Hypertext Transmission Protocol).

Except for software 104, database 106, server 102 and client devices 112 represent a broad range of such elements known in the art, or to be designed (as long as they are consistent with the teachings of the present invention). Accordingly, except for software 104, and an example of server 102, database 106, client devices 112 and coupling 122 will not be further described.

While for ease of understanding, server 102 is “singularly” illustrated, in various embodiments, server 102 may be a single computing device, a cluster of tightly coupled computing devices, or networked computing devices.

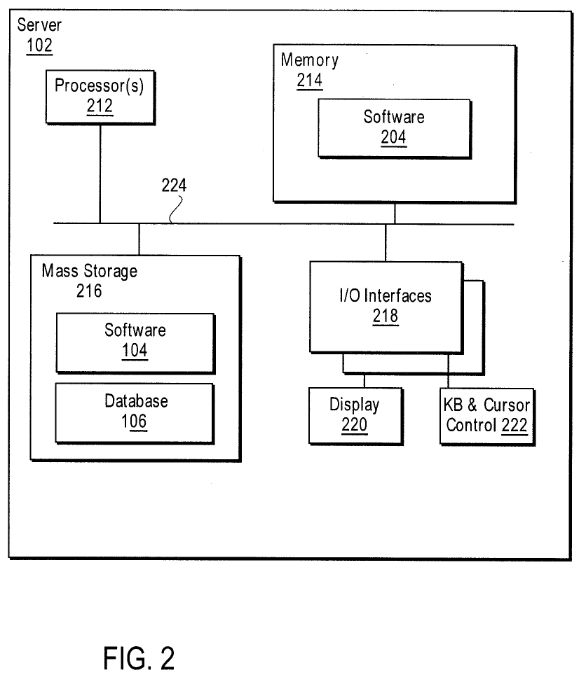

FIG. 2 illustrates an example implementation of server 102 of FIG. 1, in accordance with various embodiments of the present invention. As illustrated, server 102 includes digital computing processor 212 and memory 214 coupled to each other via bus 224. Further, device 212 includes mass storage device 216, I/O interfaces 218, and a number of I/O devices coupled to each other and the earlier described elements as shown. Memory 214 and mass storage device 216 may include, in particular, a transient and a persistent copy of software 104, respectively. Mass storage device 216 further includes database 106. The I/O devices may include, in particular, display 220 and keyboard/cursor control 222.

In various embodiments, processor 212 may be any one of a number of microprocessors known in the art, or to be designed (as long as they are consistent with the teachings of the present invention), including but are not limited to, the processors available from Intel Corp., of Santa Clara, Calif.

Memory 214 may likewise be any one of a number of volatile storage known in the art or to be designed (as long as they are consistent with the teachings of the present invention), including but are not limited to, the volatile storage available from Kingston Technology of Fountain Valley, Calif. Mass storage device 216 may likewise be any one of a number of non-volatile storage known in the art or to be designed (as long as they are consistent with the teachings of the present invention), including but are not limited to, the non-volatile disk storage available from Seagate of Scotts Valley, Calif.

In various embodiments, I/O interfaces 218 include a communication interface for coupling server 102 to client devices 112. The communication interface may be a wire based or wireless interface, coupling server 102 to devices 112 via a wired/wireless local/wide area network. An example of a suitable wired network interface includes but is not limited to an Ethernet interface, and an example of a suitable wireless network interface includes but is not limited to an IEEE 802.11b (working group) network interface.

Except for software component 104 (described further herein), and the manner these elements are employed, each of these elements represents a broad range of the corresponding element known in the art or to be designed, consistent with the teachings of the present invention. The elements perform their conventional functions, i.e. processing, storage, reading, displaying, and so forth. While for ease of understanding, software component 104 is “singularly” illustrated, in various embodiments, software component may be a single or a plurality of processes, executed as a single thread or multiple threads, on a single or multiple processors.

As used herein, the term “component” is intended to refer to programming logic and associated data that may be employed to obtain a desired outcome. The term component may be synonymous with “module” or “agent” and may refer to programming logic that may be embodied in hardware or firmware, or in a collection of software instructions, possibly having entry and exit points, written in a programming language, such as, for example, C++, Intel Architecture 32 bit (IA-32) executable code, etc.

A software component may be compiled and linked into an executable program, or installed in a dynamic link library, or may be written in an interpretive language such as BASIC. It will be appreciated that software components may be callable from other components or from themselves, and/or may be invoked in response to detected events or interrupts. Software instructions may be provided in a machine accessible medium, which when accessed, may result in a machine performing operations or executions described in conjunction with components of embodiments of the present invention. Machine accessible medium may be firmware, e.g., an electrically erasable programmable read-only memory (EEPROM), or other recordable/non-recordable medium, e.g., read-only memory (ROM), random access memory (RAM), magnetic disk storage, optical disk storage, etc. It will be further appreciated that hardware components may be comprised of connected logic units, such as gates and flip-flops, and/or may be comprised of programmable units, such as programmable gate arrays or processors. In some embodiments, the components described herein are implemented as software modules, but nonetheless may be represented in hardware or firmware. Furthermore, although only a given number of discrete software/hardware components may be illustrated and/or described, such components may nonetheless be represented by additional components or fewer components without departing from the spirit and scope of embodiments of the present invention.

In embodiments of the present invention, an article of manufacture may be employed to implement one or more methods as disclosed herein. For example, in exemplary embodiments, an article of manufacture may comprise a storage medium and a plurality of programming instructions stored in the storage medium and adapted to implement one or more methods as disclosed herein in one or more client devices or servers. In various embodiments, programming instructions may be adapted to implement a browser, and in various ones of these embodiments, a browser may be adapted to allow a user to display information related to a network access. In an exemplary embodiment, programming instructions may be adapted to implement a browser on a client device.

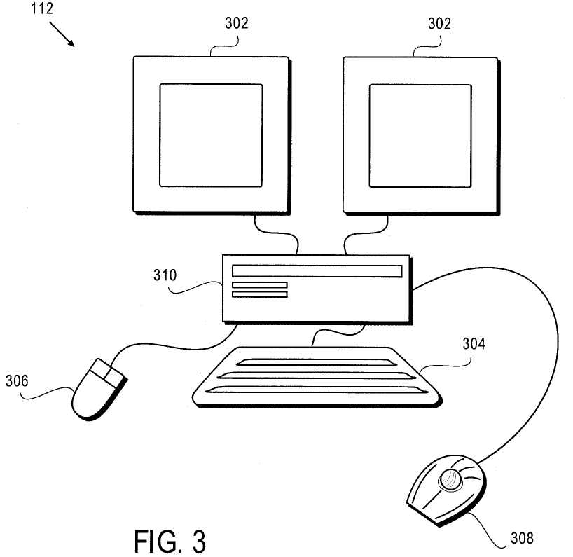

FIG. 3 schematically illustrates an example for a client device 112. Client device 112 may include one or more displays 302. Additionally, client device 112 may include one or more user inputs such as, for example, a keyboard 304, a mouse 306 and/or a track ball 308. Additionally, keyboard 304 may include devices thereon that simulate functions of, for example, a mouse or a track ball. Such devices include, for example, a mouse pad, a small joy stick-device, etc. Client device 112, in accordance with various embodiments, may also include a computer-type device 310 that may include many of the components discussed above with reference to FIG. 2. Computer-type device 310 may be communicatively coupled to a server 102, as described above with reference to FIG. 2, for receiving data from database 106 and for execution of all or part of software 104. In certain embodiments, display 302 and inputs 304-308 may be coupled directly to the server. In accordance with various embodiments of the present invention, computer-type device 310 may include portions or even all of software 104 stored thereon.

Those skilled in the art will understand that while for simplicity and clarity, client device 112 has been described with reference to a general “desktop” computer, other types of computer devices may be used for client device 112 such as, for example, laptop computers, notebook computers, personal digital assistants, etc. Additionally, those skilled in the art will understand that client device 112 may serve as a single stand alone device incorporating some or all of the components described above with reference to FIGS. 1 and 2.

In accordance with various embodiments of the present invention, graphical displays are displayed on displays 302. Software 104, in accordance with various embodiments of the present invention, may allow for selection of an axis 400 of one graphical display 402 by a user via one of inputs 304-308. Software 104, in accordance with various embodiments, may then allow for movement of an indication 400i of the axis 400 to another graphical display 404 and alignment of the indication 400i of the axis 400 with another axis 406 displayed in graphical display 404.

In accordance with various embodiments of the present invention, software 104 changes axis 406 within graphical display 404 to correspond to axis 400 within graphical display 402. In accordance with various embodiments, software 104 also automatically alters the displayed data within graphical display 404 with respect to axis 406 and any other axis 408 of graphical display 404. In accordance with various embodiments of the present invention, the axes 400, 406 relate to time components and are generally the horizontal axis within a graph, often referred to as the X axis.

In accordance with various embodiments of the present invention, the selection of an axis and its indication and movement of the indication to another graphical display comprises using mouse 306, or similar input device, to click on the selected axis, drag the indication to the new axis and release to thereby cause the newly selected axis to correspond to the originally selected axis.

Those skilled in the art will understand that other axes, in accordance with various embodiments of the present invention, may be changed and/or altered in a similar manner to that which has been described.

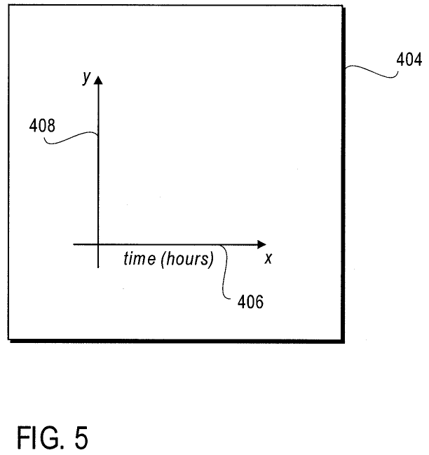

Thus, as an example, in accordance with various embodiments of the present invention, a first graphical display 402 on one of the displays 302 includes an X axis 400 having units of time corresponding to hours. By selecting axis 400 and moving an indication 400i of the axis 400 to another graphical display 404, either on the same display 302 or a different display associated with client device 112, and placing the indication 400i on or substantially near X axis 406 of the graphical display 404, X axis 406 changes from minutes to hours, as may be seen in FIG. 5. Data displayed on graphical display 404 will now be displayed with reference to hours, when it was originally displayed with respect to minutes. In accordance with various embodiments, such a transition of the display of the data occurs automatically. In accordance with other embodiments of the present invention, further user input may be required for the data to change.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method comprising:
providing at least two graphical displays on at least one display of a computer system;
moving an indication for an axis from a graphical display to another axis of another graphical display in response to input by a user via a graphical user interface; and
changing the another axis of the another graphical display to correspond to the axis of the graphical display based upon movement of the indication.

2. The method of claim 1, wherein moving an indication for an axis from a graphical display to another axis of another graphical display comprises moving the indication from one display to another display within the computer system.

3. The method of claim 1, wherein moving an indication for an axis from a graphical display to another axis of another graphical display comprises moving the indication within a single display within the computer system.

4. The method of claim 1, wherein the axis and the another axis correspond to a measurement of time for their corresponding graphical displays.

5. The method of claim 4, wherein the axis and the another axis are horizontal axes within their corresponding graphical displays.

6. The method of claim 1, wherein moving an indication for an axis from a graphical display to another axis of another graphical display based upon input by a user via a graphical user interface comprises dragging the indication from the graphical display to the another graphical display.

7. A computer system comprising:
at least one display;
a processor; and
memory coupled to the processor and including instructions thereon to cause the processor to move an indication for an axis from a graphical display displayed on the at least one display to another axis of another graphical display displayed on the at least one display in response to input by a user via a graphical user interface, and to change the another axis of the another graphical display to correspond to the axis of the graphical display based upon movement of the indication.

8. The computer system of claim 7, wherein the computer system comprises at least two displays and the instructions may cause the processor to move the indication from one display to another display within the computer system.

9. The computer system of claim 7, wherein the computer system comprises one display and the instructions may cause the processor to move the indication within the display within the computer system.

10. The computer system of claim 7, wherein the axis and the another axis correspond to a measurement of time for their corresponding graphical displays.

11. The computer system of claim 10, wherein the axis and the another axis are horizontal axes within their corresponding graphical displays.

12. The computer system of claim 7, further comprising a user input that may be used by a user to drag the indication from the graphical display to the another graphical display.

13. An article of manufacture comprising:
a storage medium; and
a plurality of instructions stored in the storage medium and designed to enable one of a processor or a server to perform a plurality of operations including:
providing at least two graphical displays on at least one display of a computer system;
moving an indication for an axis from a graphical display to another axis of another graphical display in response to input by a user via a graphical user interface; and
changing the another axis of the another graphical display to correspond to the axis of the graphical display based upon movement of the indication.

14. The article of manufacture of claim 13, wherein moving an indication for an axis from a graphical display to another axis of another graphical display comprises moving the indication from one display to another display within the computer system.

15. The article of manufacture of claim 13, wherein moving an indication for an axis from a graphical display to another axis of another graphical display comprises moving the indication within a single display within the computer system.

16. The article of manufacture of claim 13, wherein the axis and the another axis correspond to a measurement of time for their corresponding graphical displays.

17. The article of manufacture of claim 16, wherein the axis and the another axis are horizontal axes within their corresponding graphical displays.

18. The article of manufacture of claim 13, wherein moving an indication for an axis from a graphical display to another axis of another graphical display based upon input by a user via a graphical user interface comprises dragging the indication from the graphical display to the another graphical display.
